(19) United States
(12) Patent Application Publication
(10) Pub. No.: US 2012/0137230 A1
(43) Pub. Date: May 31, 2012

(54) Motion enabled data transfer techniques

(76) Inventor: Michael Domenic Forte, Austin, TX (US)

(21) Appl. No.: 13/374,443

(22) Filed: Dec. 29, 2011

Related U.S. Application Data
(63) Continuation-in-part of application No. PCT/US2010/001838, filed on Jun. 23, 2010.

(51) Int. Cl. G06F 3/01

(52) U.S. Cl. 715/748

(57) ABSTRACT

A method of transferring data between computing devices by way of asynchronous enablement is disclosed, the method comprising: receiving a user gesture input at a first computing device; receiving a user voice command; determining whether the user gesture input forms one of a plurality of different motion types; determining whether the user voice command matches a user-defined voice command; and one of the following: transferring data from the first computing device to a second computing device, in response to a determination that a second computing device is available for the reception of data, and transferring data from the first computing device to a server, in response to a determination that a second computing device is not available for the reception of data.

### CROSS REFERENCE TO RELATED APPLICATIONS

This application is a continuation-in-part of co-pending international application PCT/US2010/001838 having an international filing date of 23 Jun. 2010 and a priority date of 29 Jun. 2009.

### STATEMENT REGARDING FEDERALLY SPONSORED RESEARCH OR DEVELOPMENT

Not Applicable

### REFERENCE TO SEQUENCE LISTING

Not Applicable

### BACKGROUND

The present invention is in the technical field of mobile communication using motion sensors such as touch pads, touch screens, and accelerometers to initiate a data transfer.

More particularly iPhones, and similar mobile devices that include such motion sensors, are being used to visualize these motions audio-visually on the device screen. The current shortcoming of transferring data using such motions is limited, for example to establish a connection; both devices must experience a same or similar motion.

This invention takes a new approach and allows for asynchronous connections to enable total freedom for the user and solve the problem of complicated data transfers.

### SUMMARY OF THE INVENTION

In one embodiment, the invention is a system and technique for transferring data using a hand or wrist motion or gesture from one mobile device to another. Only the sender initiates the transfer with such motion. The receiver device will get an instant notification and can either accept or deny it. Without the receiver device having to experience the same motion, a lot more freedom is granted to the user.

In another embodiment, the invention is a system and technique for transferring data using a combination of a hand or wrist motion and speech to initiate data transfer.

### BRIEF DESCRIPTION OF THE DRAWINGS

FIG. 1: Block Diagram Mobile Device

FIG. 2: Block Diagram, Connection between Mobile Devices

FIG. 3: Block Diagram, Asynchronous Connection between Mobile Devices

FIG. 4: Block Diagram, Asynchronous Connection Sender Mobile Device to Data Server

FIG. 5: Block Diagram, Asynchronous Connection Data Server to Receiver Mobile Device

FIG. 6: Flow Chart, Illustrating data flow during communication from Receiver Mobile Device to Sender Mobile Device

FIG. 7: Block Diagram, Image Data being visually animated to indicate data transfer status visually from Receiver Mobile Device to Sender Mobile Device

### DETAILED DESCRIPTION OF THE INVENTION

The invention uses the sensing techniques in mobile devices or laptop computers to enable data transfer upon a hand or wrist motion or gesture. The gesture is asynchronous (initiated by the user of the sending device, the receiving device will not have to make any motion). In general the asynchronous wrist motions (which can be a fling or flick motion) are animated audio-visually on the device to indicate the transfer status to the user.

The invention utilizes the ability that mobile or computing devices can communicate with each other via wireless networks, Bluetooth networks, cellular networks, or other peer to peer radio frequency communication.

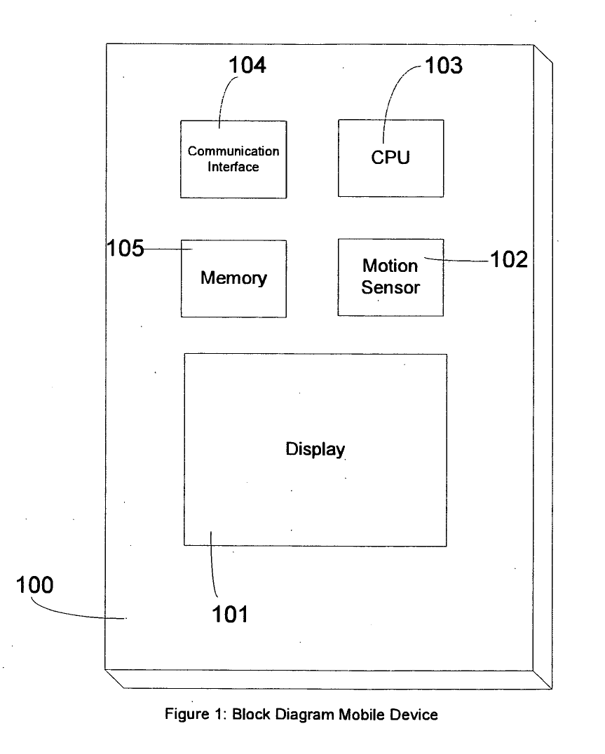

FIG. 1 is a block diagram showing a mobile device 100 which is an exemplary environment for one embodiment of the present invention. Mobile device 100 includes a display 101, Motion Sensor 102, a CPU 103, Memory 105 and a Communication Interface 104 to communicate with another device or data to recognize the motion. These components are coupled for communication with each other over a suitable bus.

The Communication Interface 104 will connect and initiate the data transfer. Communication Interface 104 can embody one or more Infrared, Bluetooth, wireless or wired Ethernet based components.

A portion of the Memory 105 is preferably allocated as addressable memory for program execution while another portion of memory 105 is used for data buffers for the data transfer. The memory will also contain an operating system supporting the program execution.

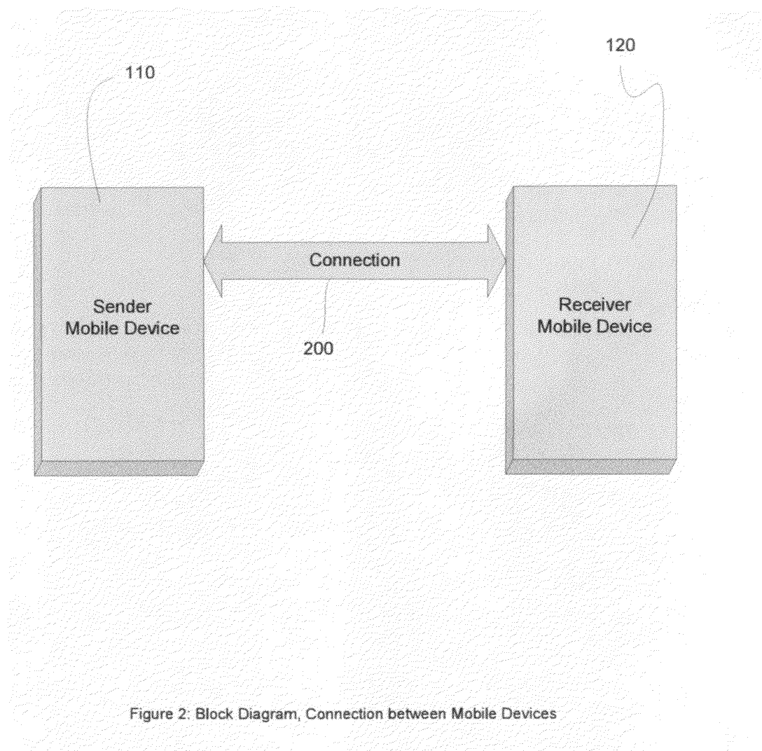

FIG. 2 shows basic data transmission when both devices are available at the same time. The Sender Mobile Device 110 will establish a Connection 200 with Receiver Mobile Device 120. If the connection is successfully established, data transfer can happen.

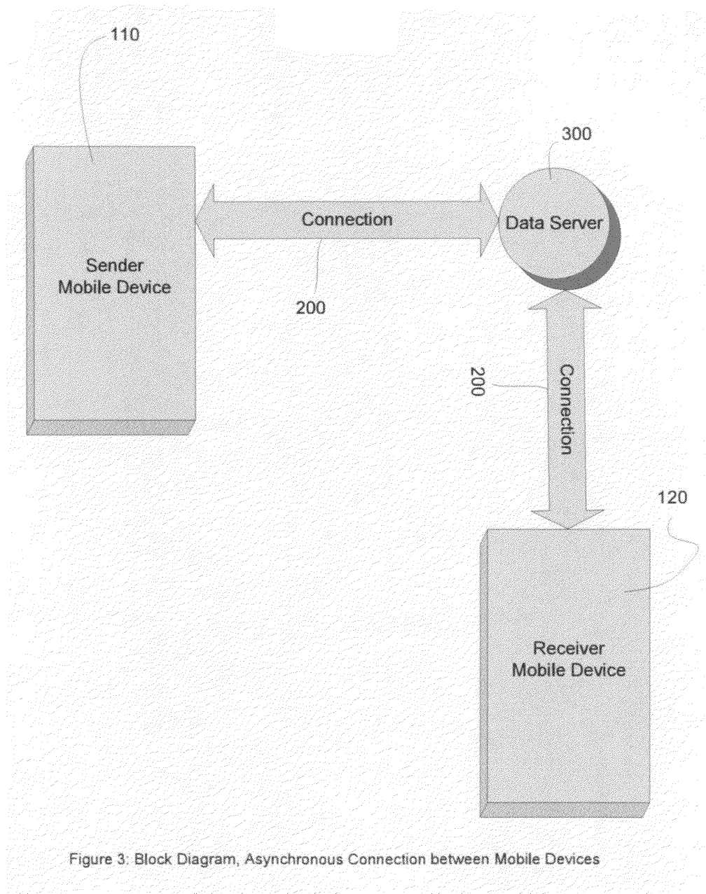

If the Receiver Mobile device is not available for a direct connection, FIG. 3 illustrates how the Mobile Sender Device 110 establishes a Connection 200 with the Data Server 300. The data will be sent to the Server. Server will then message the Receiver Mobile Device 120 via text or other messaging, that a data transmission package is available from Sender Mobile Device 110. As soon as Receiver Mobile Device 120 accepts the request, the data transfer will be established via Connection 200.

Note that the Data Server 300 includes a CPU, Memory, Storage and a Data Transfer or Communication Interface. The data server runs an Operating System as well as Software to manage and store the communications.

Referring to the invention in more detail, the Sender Mobile Device 110 will initiate sending the data with a hand or wrist motion or gesture by using the accelerometer or the touch pad, touch screen or other motion sensor 102. The sensor captures this action and audio-visually animates this action on the screen so the user gets an instant confirmation of successfully received input of the motion. The data will then be transmitted to the Receiver Mobile Device selected from a list of registered Receiver Mobile Devices available on the Data Server 300.

For example, if the user chooses the Receiver Mobile Device 120, the data will be sent as soon as the Receiver Mobile Device 120 is selected. Upon a wrist motion (throw animated as fling or flick action), using motion sensor 102, the confirmation package (as in a message of how to animate the receiving data with the motion captured by Motion Sensor 102).

The Receiver Mobile Device 120 is identified in two ways:

As shown in FIG. 2, a direct connection was possible (Receiver Mobile Device 120 ready) the data will be sent directly over Connection 200. The data sent will be represented visually as moving off the Sender Mobile Device.

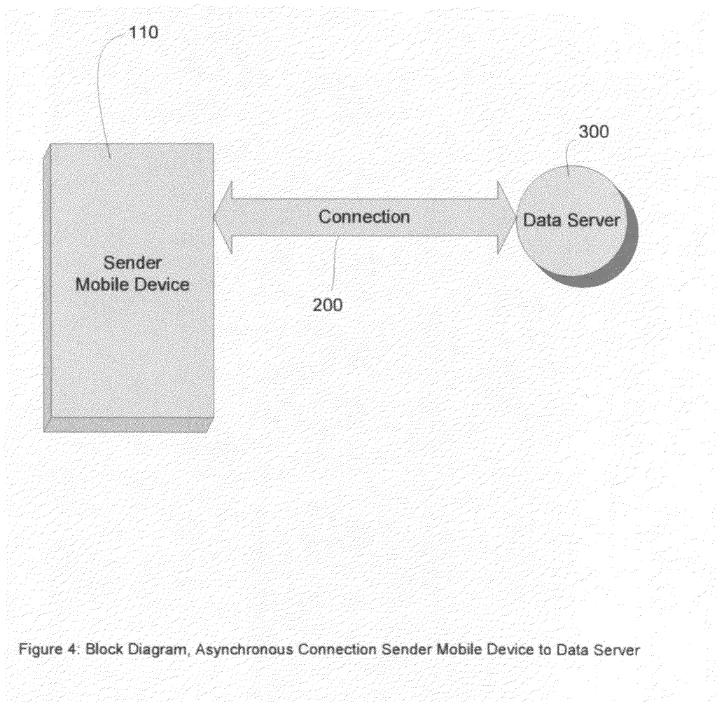

As shown in FIG. 4, a direct connection was not possible (Receiver Mobile Device 120 not ready) and the data will be sent to Data Server 300 via a direct Connection 200 to the Data Server 300. Once the data is successfully stored there, the Sender Mobile Device is notified of the pending action by visualization of the reflecting motion in the Display 101.

Both scenarios are described in more detail below:

The key to both scenarios is that during data transmit via Connection 200 the visualization will indicate the status.

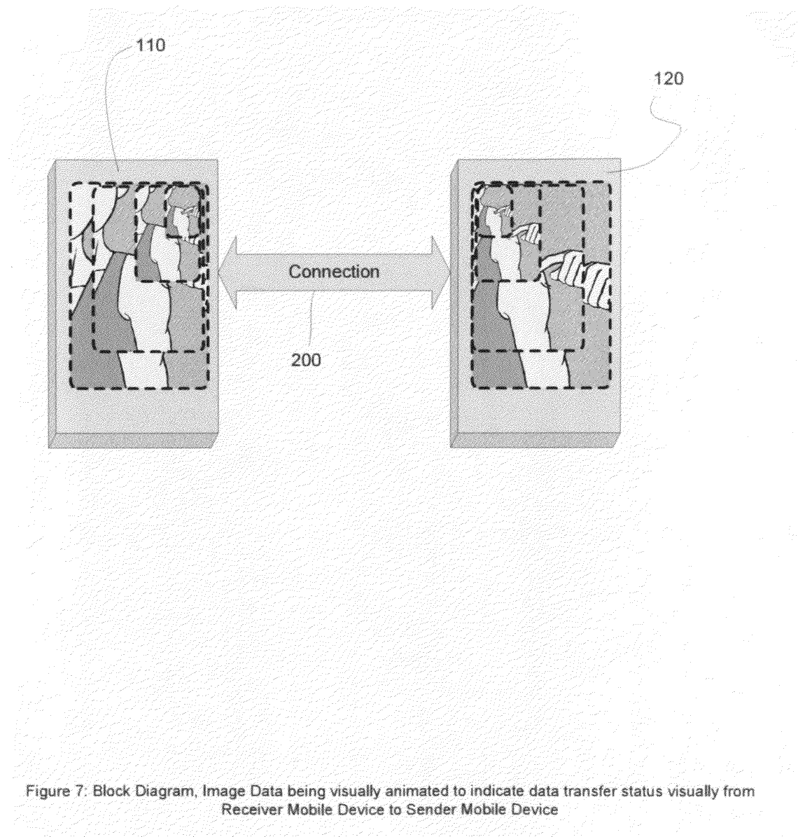

Upon direct Connection 200 with the Receiver Mobile Device (receiver ready) the data will be animated arriving at the receiver's phone similar to the audio-visual animation of the data leaving the Sender Mobile Device. This is illustrated in FIG. 7.

When the selected Receiver Mobile Device is unavailable, the data will be animated and sent to the Data Server 300. The data server will store the data and animation data captured by sensor and/or accelerometer. The Data Server will then lookup the Receiver Mobile Device 120 and sends a short text only notification with a request to accept or deny the incoming data.

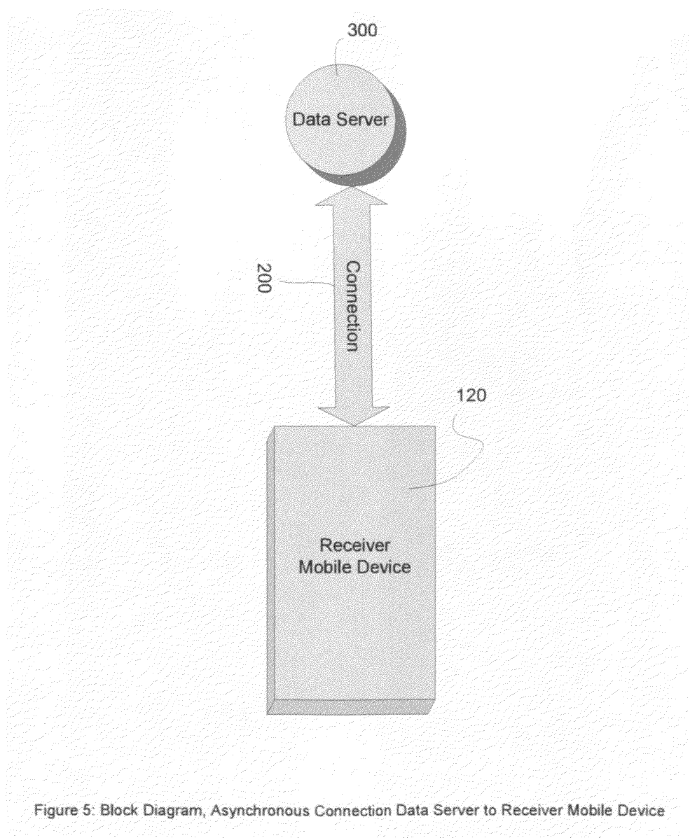

As illustrated in FIG. 5, upon acceptance of the incoming data, the data will be sent and animated to the Receiver Mobile Device 120 from the Data Server 300 via connection 200. The animation of the data will indicate the transfer status on the Display 101. Upon full receipt of the message a full image representation of the data will be shown. Once there is no more animation, the data is fully received.

As shown in FIG. 7, the Sender Mobile Device 110 shows an example of visually animated data being sent and received on the Display 101. The Receiver Mobile Device is illustrated to receive the visually animated data in inverse manner indicating the transfer status Animations can be used (based on the accelerometer or motion sensor data) and is sent as the last package. This serves as an acknowledgement that all data had been transmitted.

Data can be transmitted this way to many Mobile Devices 100 and is not just limited to one.

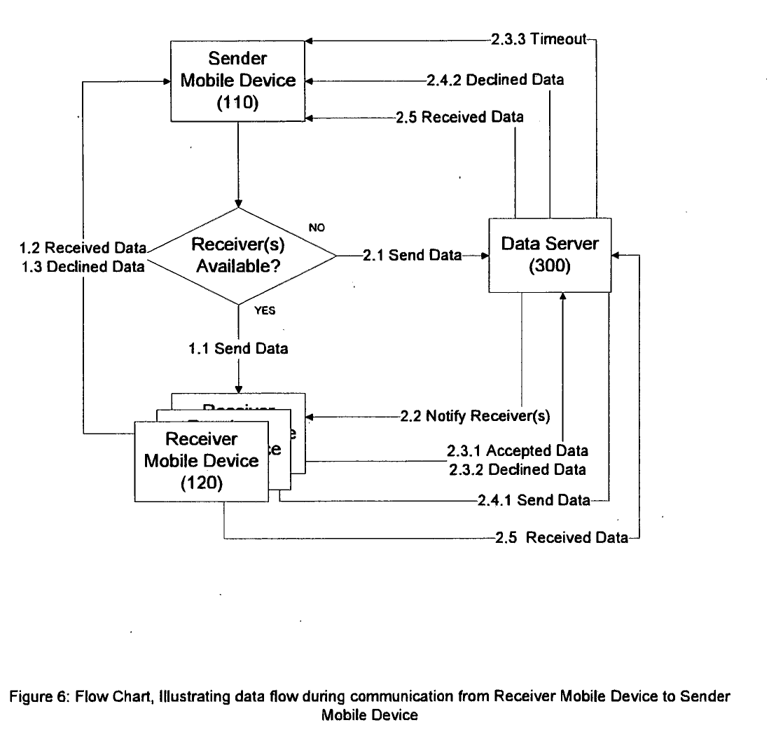

In further detail, still referring to the invention of FIG. 3, to design such software needs careful attention of the data transfer protocol. FIG. 6 illustrates the communication in a flow chart style how a Sender Mobile Device can send data to Receiver Mobile Devices or even multiple Receiver Mobile Devices.

As described, Send Data takes place upon a hand or wrist motion or gesture using the Motion Sensor 102. As illustrated, if Receiver Mobile Device 120 is available, it will return a message to Sender Mobile Device that either Received Data or Declined Data. Each will be animated audio visually on Sender Mobile Device 120 Display 102.

Also as visually described in FIG. 6, if Receiver Mobile Device is not available at this time, Send Data will be sent to Data Server 300. The Data Server 300 will Notify Receiver: Receiver Mobile Device 120. The Receiver Mobile Device 120 will send a response back to the Data Server 300 of Accept Data or Decline Data. Until such message is received, the send action is pending and a time limit may be executed eventually (server timeout). If that happens, Timeout message will be sent back to the Sender Mobile Device 110 that Receiver Mobile Device was not discovered before timeout occurred. The Sender Mobile Device 110 will receive a visual confirmation of this.

Also as illustrated in FIG. 6, once the Data Server received the notification Accept Data on time, it will send the data Send Data to the Receiver Mobile Device 120. The Receiver Mobile Device 120 will send back a Received Data message, which will be resent by the Data Server 300 to Sender Mobile Device 110.

In case the Receiver Mobile Device messages Decline Data back to the Data Server 300, the message Decline Data will be sent to the Sender Mobile Device 110. The bounce will be animated audio-visually in Display 110 of Sender Mobile Device 110.

The packet and buffer size dimensioning needs to be taken into consideration to allow for uninterrupted data transfer.

The animation of the data and the status shall appear in “real-time” to the user, although certain considerations have to be taken into account such as the data throughput rate of the communication network of choice.

The Communication Interface 104 as shown in FIG. 1 can be comprised of multiple network technologies to make data transfer most efficient. For example a combination of Wireless Ethernet and Bluetooth can be used (Bluetooth for the direct connection and Wireless Ethernet for the Server Connection).

The network protocol needs to have a function to identify users in the vicinity. The Data Server 300 keeps a record of who is available and who is not. Dimensioning of buffer sizes can vary and will be added for each connection type in the final patent application.

The advantages of the invention include, without limitation, an asynchronous data transfer to one or many devices which is initiated with a hand or wrist motion or gesture that is captured by a sensor or accelerometer. Due to the asynchronous transfer method more flexibility is granted to the user over other, synchronized methods. Data can be stored on a data server until receiver mobile device decides to accept the incoming data. The utilization of the server does not require the receiver device to duplicate the same motion which was initiated by the sender mobile device. Data transfer via a hand or wrist motion or gesture is a huge advantage over current methods of sending data due to its simple and intuitive nature.

This new way of transferring data has many advantages to the way mobile device users transfer data. The visual and audio feedback during the transaction gives the users a real live animation of what is happening. Even children of young age who are not yet able to read can communicate in this way. It is also possible to communicate with people not speaking the same language as it is implicit in the animation as to what is happening.

The visual and audio feedback during transfer eliminates the need for cumbersome dialog messages (for protocol acknowledgements and connections) and also eliminates the uncertainty of what is going on, as the transfer is animated in real-time to the user. Even though the user is using an electronic, mobile or laptop device the experience is much more like a real action and is a more natural way of transferring data from one device to another.

In broad embodiment, the invention can also be applied to non-mobile devices as long as there is a type of Motion Sensor 101 present, allowing a hand or wrist motion or gesture that can be captured and animated.

In order to exchange images and data objects from one mobile device to another mobile device or a PC, there is currently no easy, user friendly solution. The technologies are open and exist, but no common standard or technique has been developed. Also, data transfer is usually not very visual and does not show the user the current connection status. This invention would like to solve the problem to allow asynchronous data transfer using motion animation to indicate and visualize the actual data transfer.

Some operating systems allow a file sharing functionality, but if you want to connect to a device with a different operating system, this functionality may not be given anymore. A lot of mobile devices come with different operating systems and may not have the functionality at all to share data besides sending SMS text messages or MMS messages (in case the device has a connection to a phone network). This shall be purely based on LAN and WAN data transfer and free the user of requiring an actual phone connection. Furthermore current inventions and products do not include a connection and visualization upon a certain motion. Modern mobile devices include motion sensors that are not much utilized yet for data transfer.

Despite there are inventions on connecting to another device via motion detection, these inventions and products we have found require both sender and receiver device to experience the same motion. We found this a bit limited and were looking for a different approach. As in real life, when you throw something, it may or may not receive the recipient. This work is approaching an asynchronous method where the receiver may not have to be ready to receive at the same time the sender is “throwing” (sending). We have evaluated this method and implemented it in a small iPhone application prototype as proof of concept.

As a result we have come up with a new, more user interactive and fun method to transfer data from one mobile device to another using the asynchronous method. We believe this will solve the cumbersome existing methods and become the new method to exchange data from mobile device to mobile device. We are currently implementing this in into an iPhone application product and hope to soon have many more mobile device models implementing this method, solving the problem of cumbersome data transfer.

The invention may be a method of transferring data between computing devices by way of asynchronous enablement, the method comprising: receiving a user gesture input at a first computing device; determining whether the user gesture input forms one of a plurality of different motion types; and transferring data from the first computing device to a second computing device, in response to a determination that a second computing device is available for the reception of data. The method may comprise the step of receiving an output of an accelerometer, touch pad, touch screen, or other motion sensor of the first computing device. The output may be indicative of a fling or flick motion. The method may comprise the step of animating a transfer status audio-visually on the first computing device. The data may be transferred simultaneously to a plurality of available devices, in response to a determination that a plurality of computing devices is available for the reception of data. The data may be transferred between the first and second computing devices by Infrared, Bluetooth, wireless, wired Ethernet cellular network, other peer-to-peer communication, or a combination thereof.

The invention may be a method of transferring data between computing devices by way of asynchronous enablement, the method comprising: receiving a user gesture input at a first computing device; determining whether the user gesture input forms one of a plurality of different motion types; transferring data from the first computing device to a server, in response to a determination that a second computing device is not available for the reception of data. The server may transfer a text or message notification of available data to a desired second computing device from said server. The server may transmit data to the second computing device upon a determination that the second computing device indicates acceptance of a data transfer. The data may be transferred between the first and second computing devices by Infrared, Bluetooth, wireless, wired Ethernet cellular network, other peer-to-peer communication, or a combination thereof. Receiving the gesture input may comprise receiving an output of an accelerometer, touch pad, touch screen, or other motion sensor of the first computing device. The output may be indicative of a fling or flick motion. The method may comprise the step of animating a transfer status audio-visually on the first computing device.

The invention may be a computing device comprising: means for receiving a user gesture input; means for determining whether the user gesture input is indicative of a fling or flick motion; means for transferring data to a second computing device, in response to a determination that a second computing device is available for the reception of data; and means for transferring data to a server, in response to a determination that a second computing device is not available for the reception of data. The computing may comprise means for animating a transfer status audio-visually on the computing device.

The invention may be a technique for transmitting data using motion that is not peer-to-peer based, but rather server architected. Location based geo tagging (knowing where other users are via gps) may be used to find recipients. Proximity based discovery (auto scanning within 100 feet to find nearby users) may also be used.

Where the invention is a technique for transmitting data using both a motion and speech, the invention may include the step of making a throwing or flick gesture with a computing device while speaking the name of a recipient or device, such as a person's name within the contact list, TV, or stereo. The device may guess the intent of a user and provide the user with the most likely option, with the option to override for a different function or recipient. One example is the case in which a user may wish to stream a video file to his TV next to the user. The user selects a movie from the phone gallery or from a web site and performs a throwing or flick motion while saying “TV”. The computing device will automatically guess that the user wishes to play back a video on the TV and suggest this as the default action to the user. Another example is using the verbal command “pay” while throwing or flicking as a user stands next to a payment terminal.

The computing device may detect proximity to a recipient device by detecting that both devices are on the same Wi-Fi network, visible via Bluetooth, sharing the same mobile cell tower, or in close proximity based on their respective GPS coordinates.

The computing device may also be used to download content to the computing device by use of a different motion. For example, while a throwing or flick motion might be used to send content to another device, a waving motion might be used to download content to the current device.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

I claim:

1. A method of transferring data between computing devices by way of asynchronous enablement, the method comprising:
receiving a user gesture input at a first computing device;
receiving a user voice command;
determining whether the user gesture input forms one of a plurality of different motion types;
determining whether the user voice command matches a user-defined voice command; and one of the following:
transferring data from the first computing device to a server, then transferring data from the server to a second computing device, in response to a determination that a second computing device is available for the reception of data, and
transferring data from the first computing device to a server, in response to a determination that a second computing device is not available for the reception of data.

2. The method of claim 1, wherein receiving the gesture input further comprises receiving an output of an accelerometer, touch pad, touch screen, or other motion sensor of the first computing device.

3. The method of claim 2, wherein the output is indicative of a fling or flick motion.

4. The method of claim 1, wherein the method further comprises the step of animating a transfer status audio-visually on the first computing device.

5. The method of claim 1, wherein the data is transferred simultaneously from the server to a plurality of available devices, in response to a determination that a plurality of computing devices is available for the reception of data.

6. The method of claim 1, wherein the server transfers data to said second computing device upon a determination that the second computing device indicates acceptance of a data transfer.
